(19) United States
(12) Patent Application Publication
(10) Pub. No.: US 2009/0047393 A1
(43) Pub. Date: Feb. 19, 2009

(54) System for combining ice cream and coatings

(75) Inventor: Stan Jones, Vienna, IL (US)

Correspondence Address: STOCKWELL & SMEDLEY, PSC, 861 CORPORATE DRIVE, SUITE 200, LEXINGTON, KY, 40503, US

(73) Assignee: Dippin' Dots, Inc., Paducah, KY (US)

(21) Appl. No.: 11/891,756

(22) Filed: Aug. 13, 2007

(51) Int. Cl. A23G 9/48; A23G 9/00; A23G 9/04; A23P 1/08; A23G 9/24

(52) U.S. Cl. 426/101; 426/302; 426/418; 426/580; 99/450.1

(57) ABSTRACT

A system and mechanism for forming discrete units of ice cream is disclosed utilizing cryogenically cooled equipment during the manufacturing process. The discrete units are formed and then coated with one or more various confectionary substances, also using cryogenically cooled equipment, so as to result in a substantially uniformly-coated ice cream product.

### FIELD OF THE INVENTION

The present invention relates to an ice cream mechanism, and more particularly to a system and mechanism for forming and then coating units of ice cream.

### BACKGROUND OF THE INVENTION

Ice cream products are known to be popular. However, there is also a market for combining ice cream shapes with various coatings. By adding such coatings to ice cream shapes, the variety of flavors and products can be greatly increased. However, many types of coatings have difficulty being uniformly applied at temperatures where the ice cream is solid or semi-solid. As a result, coated ice cream products may sometimes be unintentionally produced which are unappealing in either taste or appearance, or both. Consequently, an improved system for combining ice cream with coatings is desired. The need for such improvement is especially great with regards to ice-cream type food products formed using cryogenically cooled equipment.

### SUMMARY OF THE INVENTION

One aspect of the present invention relates to a method for producing coated frozen food products. In accordance with this method, ice cream is formed into a plurality of substantially uniformly-shaped units and the units are conveyed along a conveyor, the conveyor being cryogenically cooled. The units are then covered with at least one coating while the units are within a cryogenically cooled container. Ultimately, the units are removed from the cryogenically cooled container and can be stored in a frozen form.

Another aspect of the present invention relates to an apparatus for producing coated frozen food products. This apparatus includes a) a first and second cylindrical roller adjacent one another such that an aperture is formed along a respective major axis of each roller, each roller having a plurality of indentations and being rotatable around their respective longitudinal axis; b) an ice cream feeder positioned so as to feed ice cream to the aperture to pass between the first and second cylindrical roller and be forced into at least some of the indentations to form a plurality of substantially uniformly-shaped units; c) a conveyor positioned to catch the plurality of substantially uniformly-shaped units, the conveyor being maintained at a cryogenic temperature; and d) a cryogenically cooled container configured to receive the units from the conveyor and cover the units with at least one coating. In this way, a frozen confection can be cryogenically made but use far less liquid nitrogen and cost far less than other known methods of making such confections.

It is understood that other embodiments of the present invention will become readily apparent to those skilled in the art from the following detailed description, wherein it is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

FIG. 1 shows a stamping mechanism for stamping or pressing ice cream into uniform shapes or units in accordance with the principles of the present invention;

FIG. 2 shows a flowchart of the steps for operating the stamping mechanism of FIG. 1;

FIG. 3 shows a coating mechanism for applying a coating to the various units in accordance with the principles of the present invention;

FIG. 4 shows a flowchart of the steps for operating the coating mechanism of FIG. 3; and

FIG. 5 shows more detail of the coating mechanism of FIG. 3.

### DETAILED DESCRIPTION OF THE PREFERRED EMBODIMENTS

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

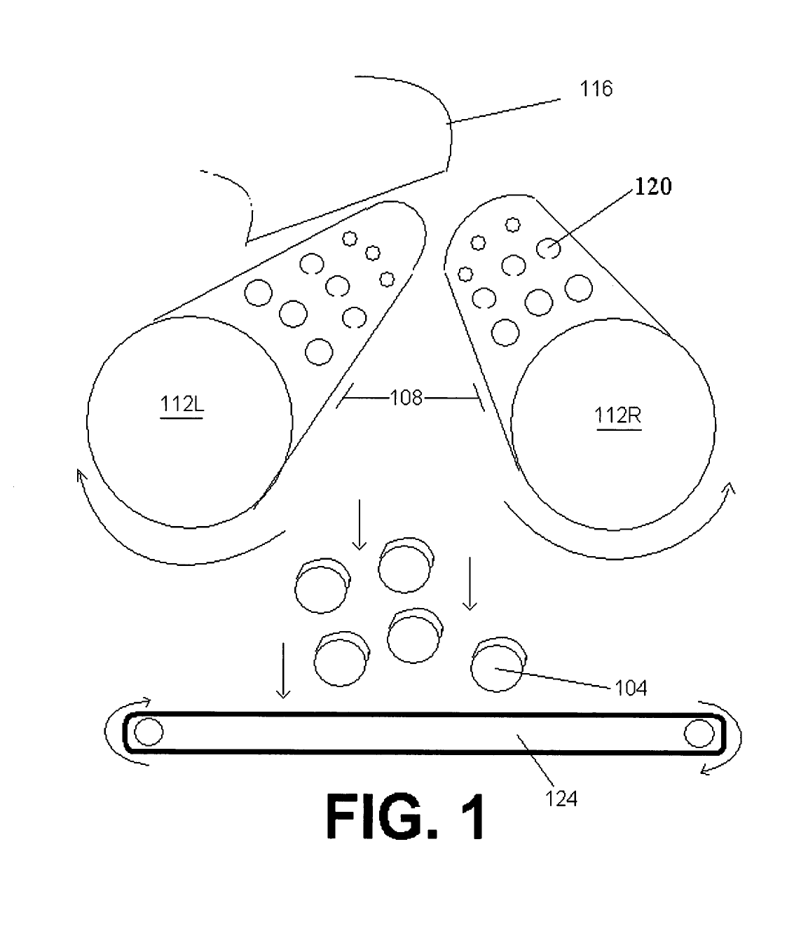

FIG. 1 shows a mechanism 100 for stamping or pressing ice cream into uniform shapes or units 104. The mechanism has an aperture 108 for admitting the ice cream to be processed. The rollers 112L and 112R have indentations 120 in various shapes, and one or both are maintained at cryogenic temperatures. For example, the rollers 112L, 112R may be partially hollow so that cryogenic fluid can be circulated within the roller. Also, the rollers may be formed as jacketed sleeves so that the cryogenic fluid can circulate between the two sleeves. As shown, the indentations 120 are formed on both rollers 112L, 112R. In operation a pair of indentations (one on each roller 112L, 112R) may become aligned substantially at the point where the ice cream 116 flows between the two rollers 112L, 112R. As this occurs, the pair of indentations forms a mold into which the ice cream 116 is forced and thus shaped into the units 104. It will be appreciated that the ice cream 116 can alternatively be shaped by a single indentation on one roller and a flat surface on the other. Thus, in an embodiment not depicted in FIG. 1, one of the rollers 112L, 112R may have no indentations 120.

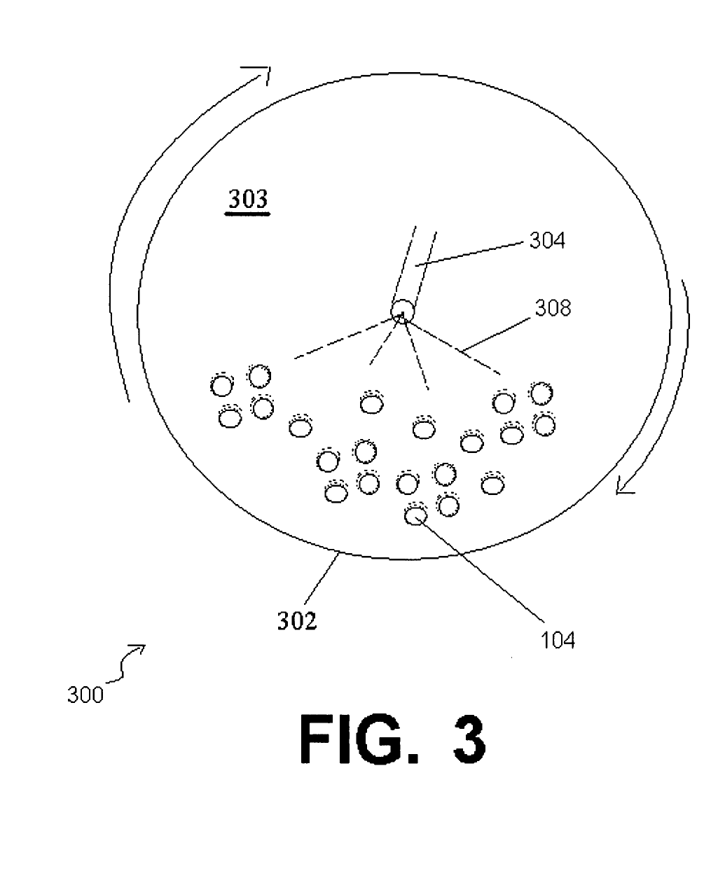

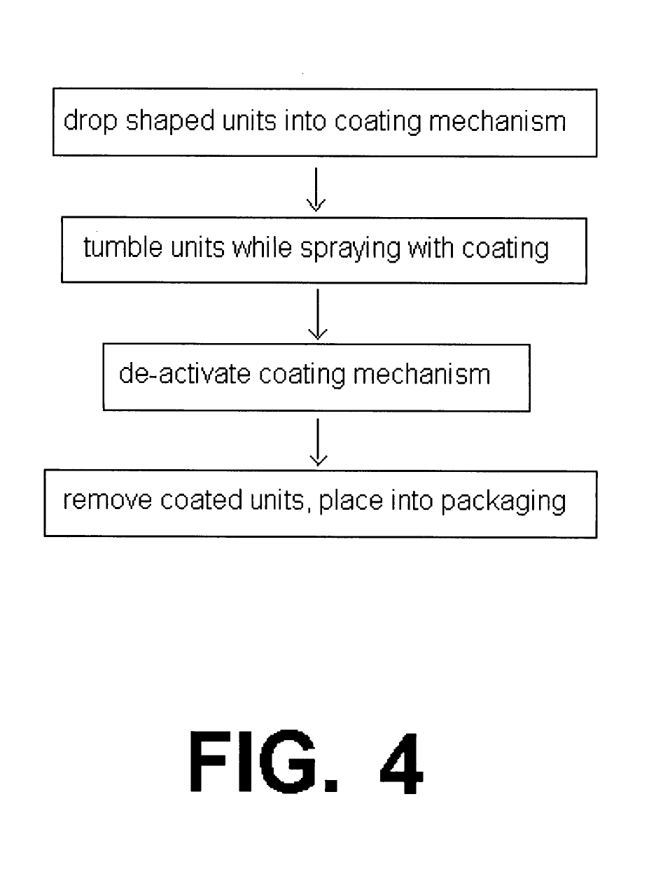

Also, rather than a flat surface on the rollers 112L, 112R, the surface may be textured so as to add a texture pattern to a surface of each of the units 104 as well. Once stamped or pressed, the units 104 are dropped by gravity onto a conveyer 124, which is also maintained at a cryogenic temperature. For example, the conveyor may be located within a trough suspended above a region where liquid nitrogen is fed. Thus, the ambient temperature near the conveyor is maintained near cryogenic temperatures. The conveyer 124 then transports the units 104 to a coating and tumbling mechanism 300 (shown in FIGS. 3 and 4, not shown in FIG. 1) for further processing.

By making the all indentations 120 the same on the rollers 112L, 112R, the resulting units 104 will be substantially similar in size and shape. While this is preferable because it assists with sorting units 104 ensuring a uniform coating during a later processing step, the indentations 120 may be shaped different from one another in order to produce different shaped or sized units 104 at the same time.

One potential shape of the unit 104 could be discs, although many other shapes are contemplated within the spirit and scope of the present invention. Other shapes could include but are not limited to hearts, spheres, footballs, or iconic symbols such as, for example, a Pac-Man symbol. The important factor is that the units 104 be a recognizable, familiar shape, and be substantially uniform in size.

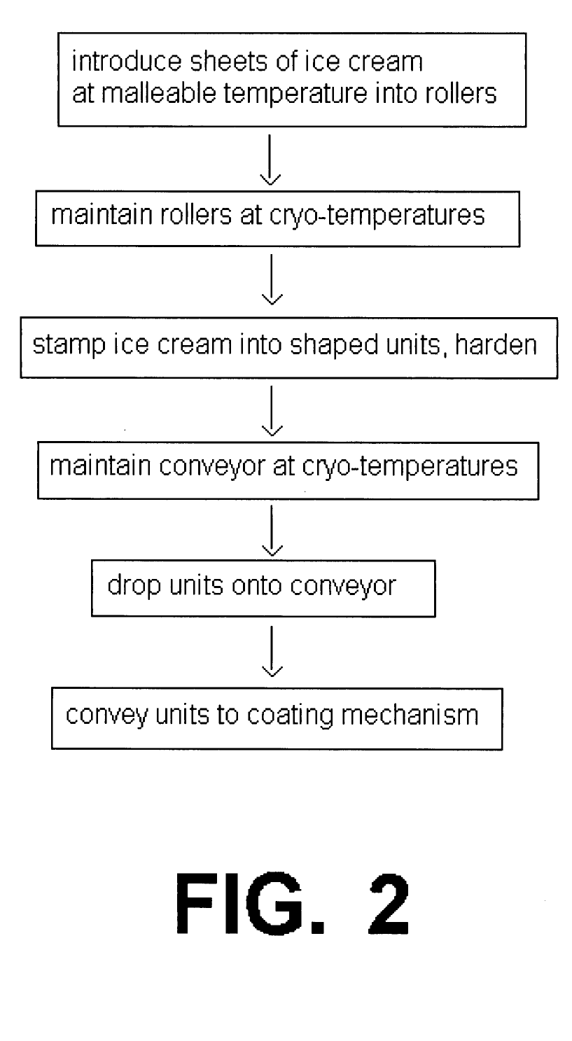

FIG. 2 shows a flowchart of the steps for operating the mechanism 100 of FIG. 1. First, ice cream is introduced at the aperture 108 in the form of a sheet 116 provided by an ice cream feeding device that can control the size of the sheet and its delivery rate. The sheet 116 extends roughly the length of the rollers 112R, 112L because the indentations 120 extend along this entire length as well. Sizing the sheet 116 in this manner ensures maximum use of all the indentations 120. The thickness of the sheet 116 depends on the desired units 104 being produced but is sufficient to ensure that the indentations 120 are uniformly and completely filled with ice cream during production. Typically, the sheet 116 can range from 5 mm to 15 mm in thickness but other thicknesses are contemplated as well. The temperature of the sheet 116 at the time it meets the aperture 108 is maintained such that the sheet 116 is still malleable and in a semi-solid form that can still be manipulated which for many ice cream products is around 28° F. but this can vary by as much as 10° F. depending on the composition of the ice cream and whether the ice cream sheet 116 is fed via gravity or via a pressurized source.

Because of the rollers 112L, 112R are generally cylindrical in nature, the aperture 108 that extends along the length or major axis of each roller exists above the rollers but is almost non-existent at the point where the two rollers meet near their centers. In this way, the sheet 116 is mechanically forced into the indentations 120 through pressure exerted by the surface of the opposite roller. As they each rotate around their center or longitudinal axis (as shown by the arrows in FIG. 1), the rollers 112L and 112R come in contact with the sheet 116 and press it into the indentations 120 that are machined into the rollers 112L and 112R. As the rollers 112L, 112R continue to rotate, the units 104 fall from the indentations 120 and drop onto the conveyor 24. Because they are cryogenically cooled, the rollers 112L and 112R underneath the aperture 108 are maintained at a much lower temperature than exists at the aperture 108. For this reason, the sheet 116 is still semi-soft and therefore malleable, but the resulting units 104 are more solidified and no longer malleable and, thus, can easily fall out of the indentations 120 via gravity. The cryogenic temperatures of the conveyor 124 assist in completing the process of hardening the units 104.

FIG. 3 shows an exemplary coating mechanism 300 for applying a coating 308 to the various units 104. The mechanism 300 includes a hopper 302 which may be roughly cylindrical in shape with an opening 303 at one end and can be rotated about an axis at its center such as, for example, by a motor coupled with gears on the outside of the hopper 302. The opening 303 may have a provision for a lid or other covering (not shown) so that the hopper 302 may be sealed if desired. One possible reason to seal the hopper 302 is to help maintain a low temperature within the hopper 302 during the coating process. The mechanism 300 sprays coating 308 on the units 104; the coating 308 is received under pressure via a fluid passageway such as from an insulated pipe 304 located within the hopper 302 and then sprayed through a nozzle at the terminating end of the pipe 304 within the hopper 302. In order to evenly and uniformly coat the units 104, the mechanism 300 operates to agitate the units 104 such as, for example, by rotating the hopper 302 so as to slowly and gently tumble the units 104 while applying the coating 308. One of ordinary skill will recognize that there are other functionally equivalent ways contemplated within the scope of the present invention to agitate the units 104 during coating so as to ensure a uniform coating of a desired thickness such as, for example, via vibration.

Portions of the coating mechanism are maintained at cryogenic temperatures. This may be accomplished by having at least a portion of the hopper 302 constructed to allow introduction of cryogenic refrigerant in or through portions of the hopper. For example, the hopper 302 may have an inner and outer sleeve so that cryogenic refrigerant may be circulated or located between the two sleeves. However, the fluid passageway, such as the insulated pipe 304, is maintained at a much higher temperature, in order to facilitate the spray-on coating 308 staying at a temperature to adhere to the units 104, and to not prematurely solidify until it hits its target. Potential coatings include, but are not limited to, candy, syrup, chocolate, butterscotch, and caramel. The particular type of coating chosen will determine the temperature at which the fluid passageway 304 must be maintained in order to ensure the coating material remains free flowing.

FIG. 4 shows a flowchart for operating the coating mechanism 300 of FIG. 3. The units 104 are dropped into the mechanism 300 from the conveyor 124 via gravity. Alternatively, the units 104 can be collected into batches from the conveyor 124 before being dropped into the coating mechanism 300. For example, an amount of units 104 for comfortably fitting within the hopper 302 can be collected at some time prior to coating and then dropped into the mechanism 300 to be coated when desirable. They are then tumbled for a predetermined period, depending partly on size and amount of units 104, and that specific formulation of ice cream's propensity for receiving and absorbing the coating 308. The duration may also depend on the density and sticking properties of the coating 308. The circular tumbling motion of the mechanism 300 also has the effect of preventing clumping of the units 104.

Although the mechanism 300 of FIG. 3 only shows one coating 308 being applied to units 104, alternative embodiments of the present invention contemplate the application of more than one coating as well. For example, a plurality of coated units may be retrieved from one mechanism 300 and then introduced into a second mechanism 300 such that two coatings may be sequentially applied in this manner. For example, a chocolate coating may first be applied to units 104 and then a hard candy coating applied over top of the chocolate. Alternatively, the mechanism 300 may be provisioned with two or more fluid passage ways (not shown) that are connected to their own respective coating materials. As a result, different coatings may be applied sequentially from each of the fluid passage ways so that the resulting product will have multiple layers of flavor. Furthermore, in an embodiment having multiple spraying mechanisms 308 within the coating mechanism 300, compound coatings having more than one component may be applied such that each component is applied concurrently with the other components instead of sequentially, as well.

After a predetermined period of time, the coating mechanism 300 is deactivated and the coated units 104 are removed. These coated units 104 can be packaged in bulk bags, or placed directly in consumer-friendly packaging that is ready for shipping or ready for retail sales. Until that time, the coated units are stored temporarily in frozen form as part of the manufacturing process.

The above processes shown in FIGS. 2 and 4 produce coated units 104 of ice cream which can be stored at −40° F. Alternatively, the coated units 104 can be stored in conventional freezers depending on the particular formulation of ice cream being used in production. The thickness of the coating also plays a role in determining the storage temperature as a thicker coating, in general, provides more insulation than a thinner coating. The thickness selected for each coating layer is a function of what attributes are desired in the resulting product. The relative taste of each flavor along with the mouth-feel of the product all play a role in determining how thick to make a particular coating. Thus, the thickness of the coating may vary from fractions of a millimeter to a few millimeters. For larger ice cream units, the thickness of the coating may even be larger. The coated units 104 can come in various sizes and thicknesses as well, including but not limited to discs having diameters of about 2.5 cm, 1.5 cm, 1 cm and 0.5 cm with varying thicknesses.

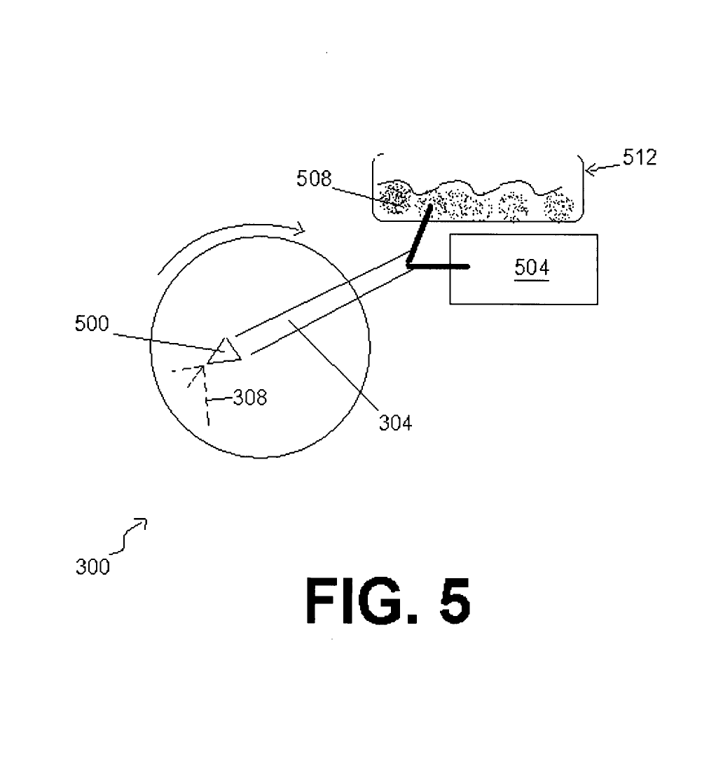

FIG. 5 shows more detail of the coating mechanism 300. As shown in FIG. 5, a nozzle 500 is attached to the end of the insulated pipe 304. The nozzle is designed to operate at specific temperatures and pressures suitable for the coating 308, and is also easily removed for cleaning. A compressor 504 assists in pumping the coating formulation 508 in its liquid state from a tank 512. The tank 512 is maintained at a specific temperature, so as to optimize the formulation 508 before it solidifies into the coating 308.

The stamping mechanism 100 also has a “return of flash” feature. Because some of the sheet 116 will not be stamped into units 104, but instead passes through the rollers 112L and 112R without contacting the indentations 120, it is necessary to capture and recycle this raw ice cream or “flash” and any smaller pieces as well. To achieve this, the stamping mechanism 100 has a return filter which ensures that only properly formed units 104 are conveyed to the coating mechanism 300. The filter acts to screen out objects that are too large and also objects that are too small to be properly shaped units 104. The remainder or flash is returned to the device that forms the sheets 116, where that flash gets another chance to be transformed into a unit 104.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with each claim's language, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

1. A method for producing coated frozen food products comprising the steps of:
forming ice cream into a plurality of substantially uniformly-shaped units;
conveying the units along a conveyor, the conveyor being cryogenically cooled;
covering the units with at least one coating while the units are within a cryogenically cooled container;
removing the units from the cryogenically cooled container; and
storing the units in a frozen form.

2. The method of claim 1, wherein the step of forming further includes the steps of:
rotating a first and second cylindrical roller adjacent one another such that an aperture is formed along a respective major axis of each roller, each roller having a plurality of indentations and;
providing the ice cream at an opening of the aperture such that the ice cream flows through the aperture between the rollers and is forced into at least some of the indentations to form the plurality of substantially uniformly-shaped units.

3. The method of claim 2, wherein at least one of the cylindrical rollers is maintained at a cryogenic temperature while rotating.

4. The method of claim 2, wherein the ice cream is provided as a sheet.

5. The method of claim 2, wherein a pair of the plurality of indentations are formed such that one of the pair is located on the first roller and another of the pair is located on the second roller and are positioned thereon to be aligned with one another at a point of rotation where the ice cream and the pair of indentations coincide.

6. The method of claim 2, wherein the ice cream is provided as a gravity-fed flow.

7. The method of claim 2, wherein the ice cream is provided as a pressurized flow.

8. The method of claim 1, wherein the ice cream has a temperature of about 28° F.

9. The method of claim 1, wherein the ice cream is in a semi-solid state that can flow by gravity.

10. The method of claim 1, further comprising the step of:
before performing the step of conveying, separating the units from any ice cream not formed into the plurality of substantially uniformly-shaped units.

11. The method of claim 1, wherein the units are shaped as one of: a disc, a sphere, a football, and an iconic symbol.

12. The method of claim 1, wherein the step of covering further includes the steps of:
agitating the units within the cryogenically cooled container; and
spraying the at least one coating on the units while they are being agitated using a nozzle located within the cryogenically cooled container.

13. The method of claim 12, wherein the nozzle is connected via a fluid passageway to a reservoir of coating material.

14. The method of claim 13, wherein the fluid passageway is maintained at a temperature that permits free flow of the coating material.

15. The method of claim 13, wherein the fluid passageway is insulated.

16. The method of claim 12, wherein agitating is performed by rotating the cryogenically cooled container.

17. The method of claim 12, wherein the at least one coating is substantially uniform on substantially all of the units within the cryogenically cooled container.

18. The method of claim 1, wherein the at least one coating is one of candy, chocolate, butterscotch, and caramel.

19. The method of claim 1, wherein the cryogenically cooled container comprises a rotatable semi-cylindrical hopper having a closable opening on a first face.

20. The method of claim 19, wherein the hopper further comprises an inner layer and an outer layer wherein refrigerant at cryogenic temperatures may be located between the inner and outer layers.

21. The method of claim 20, wherein the cryogenic refrigerant is circulated between the inner and outer layers while the hopper rotates.

22. The method of claim 1, wherein the step of storing occurs at a temperature of about negative 40° F.

23. An apparatus for producing coated frozen food products comprising:
a first and second cylindrical roller adjacent one another such that an aperture is formed along a respective major axis of each roller, each roller having a plurality of indentations and rotatable around its respective longitudinal axis;
an ice cream feeder positioned so as to feed ice cream to the aperture to pass between the first and second cylindrical roller and be forced into at least some of the indentations to form a plurality of substantially uniformly-shaped units;
a conveyor positioned to catch the plurality of substantially uniformly-shaped units, the conveyor being maintained at a cryogenic temperature; and
a cryogenically cooled container configured to receive the units from the conveyor and cover the units with at least one coating.

24. The apparatus of claim 23, wherein at least one of the first and second cylindrical roller is maintained at a cryogenic temperature.

25. The apparatus of claim 23, wherein the ice cream is formed as a sheet when being fed to the aperture.

26. The apparatus of claim 23, wherein the ice cream is in a semi-solid state that can flow by gravity when being fed to the aperture.

27. The apparatus of claim 23, wherein the cryogenically cooled container further comprises:
a semi-cylindrical hopper configured to agitate a plurality of units within the hopper; and
a sprayer located at least partially within the hopper and configured to deliver the at least one coating to the units within the hopper.

28. The apparatus of claim 27, wherein the sprayer further comprises:
a nozzle;
a reservoir of coating material; and
a fluid passageway between the nozzle and the reservoir.

29. The apparatus of claim 28, wherein the fluid passageway comprises an insulated pipe.

30. The apparatus of claim 28, wherein the sprayer is maintained at a temperature allowing free flow of the coating material.

31. The apparatus of claim 27, wherein the semi-cylindrical hopper rotates to agitate the plurality of units within the hopper.

32. The apparatus of claim 23, wherein the at least one coating is one of candy, chocolate, butterscotch, and caramel.

33. The apparatus of claim 23, further comprising:
a storage unit configured to store the units after being covered with the at least one coating.

34. A coated frozen food product manufactured by:
rotating a first and second cylindrical roller adjacent one another such that an aperture is formed along a respective major axis of each roller, each roller having a plurality of indentations;
providing ice cream at an opening of the aperture such that the ice cream flows through the aperture between the rollers and is forced into at least some of the indentations to form the plurality of substantially uniformly-shaped units;
conveying the units along a conveyor, the conveyor being cryogenically cooled;
covering the units with at least one coating while the units are within a cryogenically cooled container;
removing the units from the cryogenically cooled container; and
storing the units in a frozen form.

35. The food product of claim 34, wherein covering the units further comprises:
agitating the units within the cryogenically cooled container; and
spraying the at least one coating on the units while they are being agitated using a nozzle located within the cryogenically cooled container.

36. A method for producing coated frozen food products, comprising the steps of:
placing a plurality of substantially uniformly-shaped units within a cryogenically cooled container, each of the units comprised of solid ice cream; and
covering the units with at least one coating while in the cryogenically cooled container, the at least one coating being substantially uniform on each of the units.

37. The method of claim 1, wherein the at least one coating is suitable for a frozen food product.

38. The method of claim 23, wherein the at least one coating is suitable for frozen food.
